(19) United States
(12) Patent Application Publication
(10) Pub. No.: US 2019/0259004 A1
(43) Pub. Date: Aug. 22, 2019

(54) COMMUNICATION EVENT ANALYZATION FOR AUTOMATIC SCHEDULING SYSTEM

(71) Applicant: International Business Machines Corporation, Armonk, NY (US)

(72) Inventors: Robert Kerr, Cambridge (GB); Michael Kirwan, Cambridge (GB); Paul R. Lambson, Royston (GB); Christopher Farinton Challis, Cambridge (GB)

(21) Appl. No.: 15/899,094

(22) Filed: Feb. 19, 2018

(51) Int. Cl. G06Q 10/10; H04M 1/725; H04L 12/26; H04L 12/24

(52) U.S. Cl. CPC G06Q 10/1095; H04M 1/72566; G06Q 10/06311; H04L 41/069; H04L 43/16

(57) ABSTRACT

A processor may maintain a profile for a set of users of the shared calendar system including a threshold of communication volume prior to scheduling a meeting. The processor may update the threshold in the profile in response to a meeting being scheduled for the set of users based on examination of communications between the set of users within a configurable time period prior to the time of scheduling the meeting. The processor may determine, after each event in a communication chain involving the set of users, whether the volume of communications within a prior time period of the duration of the configurable time period exceeds the threshold for the profile for the set of users. The processor may propose the next mutually available timeslot for the set of users in response to the volume of communications exceeding the threshold.

### BACKGROUND

The present disclosure relates generally to the field of electronic docketing, and more specifically to automatic scheduling in a shared calendar system.

Co-workers in an office environment often work most efficiently by using collaboration tools such as email and instant messaging to communicate. However, when the volume of digital communications has a negative impact on efficiency, co-workers may need to schedule a meeting to discuss issues and decide how to proceed. In these cases, a lack of overlapping availability can incur delays and/or the need to reschedule existing meetings.

### SUMMARY

Embodiments of the present disclosure include a method, system, and computer program product for automatic scheduling in a shared calendar system. A processor may maintain a profile for a set of users of the shared calendar system including a threshold of communication volume prior to scheduling a meeting. The processor may update the threshold in the profile in response to a meeting being scheduled for the set of users based on examination of communications between the set of users within a configurable time period prior to the time of scheduling the meeting. The processor may determine, after each event in a communication chain involving the set of users, whether the volume of communications within a prior time period of the duration of the configurable time period exceeds the threshold for the profile for the set of users. The processor may propose the next mutually available timeslot for the set of users in response to the volume of communications exceeding the threshold.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 is a schematic diagram illustrating multiple users in a shared calendar environment, in accordance with embodiments of the present disclosure.

FIG. 2 is a flow diagram of an example method for proposing timeslots in a shared calendar system, in accordance with embodiments of the present disclosure.

FIG. 3 is a schematic diagram illustrating a shared calendar system including a proposed timeslot, in accordance with embodiments of the present disclosure.

FIG. 4 is block diagram of an example system for determining timeslots in a shared calendar system, in accordance with embodiments of the present disclosure.

FIG. 5 illustrates a high-level block diagram of an example computer system that may be used in implementing one or more of the methods, tools, and modules, and any related functions, described herein, in accordance with embodiments of the present disclosure.

FIG. 6 depicts a cloud computing environment, in accordance with embodiments of the present disclosure.

FIG. 7 depicts abstraction model layers, in accordance with embodiments of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate generally to the field of electronic docketing, and more specifically to automatic scheduling in a shared calendar system. The described method and system provide a proposal of timeslots in a shared calendar system for a set of users. The method and system may work in association with or as an extension to a shared calendaring system in the form of networked software that allows for sharing of information between users.

According to an aspect of the present disclosure there is provided a computer-implemented method for automatic scheduling in a shared calendar system, comprising: maintaining a profile for a set of users of the shared calendar system including a threshold of communication volume prior to scheduling a meeting; updating the threshold in the profile in response to a meeting being scheduled for the set of users based on examination of communications between the set of users within a configurable time period prior to the time of scheduling the meeting; after each event in a communication chain involving the set of users, determining whether the volume of communications within a prior time period of the duration of the configurable time period exceeds the threshold for the profile for the set of users; and, in response to the volume of communications exceeding the threshold, proposing the next mutually available timeslot for the set of users.

According to another aspect of the present disclosure there is provided a system for automatic scheduling in a shared calendar system, comprising: a processor and a memory configured to provide computer program instructions to the processor to execute the function of the components: a profile component for maintaining a profile for a set of users of the shared calendar system including a threshold component for maintaining a threshold of communication volume prior to scheduling a meeting; a threshold updating component for updating the threshold in the profile in response to a meeting being scheduled for the set of users based on a monitoring component examining communications between the set of users within a configurable time period prior to the time of scheduling the meeting; a meeting determining component for, after each event in a communication chain involving the set of users, determining whether the volume of communications within a prior time period of the duration of the configurable time period exceeds the threshold for the profile for the set of users; and a meeting proposing component for, in response to the volume of communications exceeding the threshold, proposing the next mutually available timeslot for the set of users

According to a further aspect of the present disclosure there is provided a computer program product for automatic scheduling in a shared calendar system, the computer program product comprising a computer readable storage medium having program instructions embodied therewith, the program instructions executable by a processor to cause the processor to: maintain a profile for a set of users of the shared calendar system including a threshold of communication volume prior to scheduling a meeting; update the threshold in the profile in response to a meeting being scheduled for the set of users based on examination of communications between the set of users within a configurable time period prior to the time of scheduling the meeting; after each event in a communication chain involving the set of users, determine whether the volume of communications within a prior time period of the duration of the configurable time period exceeds the threshold for the profile for the set of users; and, in response to the volume of communications exceeding the threshold, propose the next mutually available timeslot for the set of users.

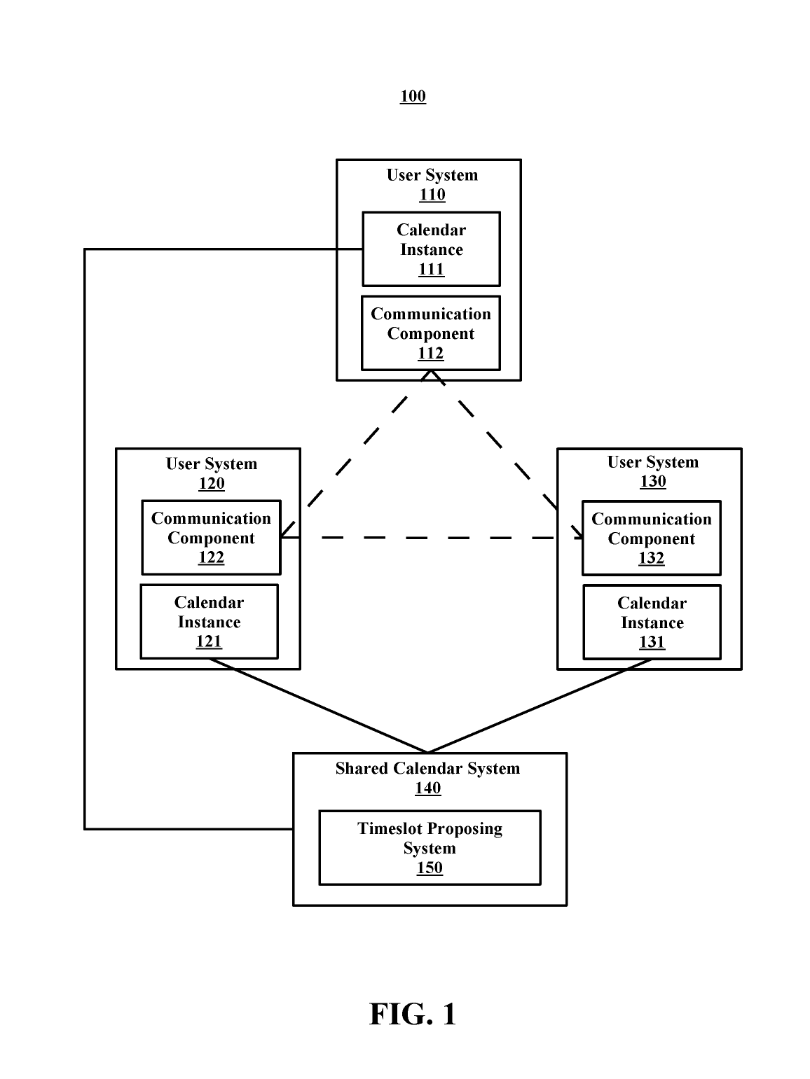

FIG. 1 depicts a schematic diagram of a collaborative communication environment 100. In some embodiments, the collaborative communication environment 100 includes a shared calendar system 140 that may be networked via calendar instances 111, 121, and 131, which are respectively on user systems 110, 120, and 130. The calendar instances 111, 121, and 131 may be downloaded software on the user systems 110, 120, and 130 or accessed via a networked service or network browser from the shared calendar system 140.

In some embodiments, a timeslot proposing system 150 is provided in association with the shared calendar system 140 and provides functionality to automatically propose timeslots to a set of users according to communication volumes between the communication components 112, 122, and 132, respectively, of the user systems 110, 120, and 130 of the set of users.

The shared calendar system 140 may include contact lists, time management tools, etc. and may be provided as part of an office suite of software. The shared calendar system 140 may include collaborative scheduling that may check availability and schedule meeting times for the participants.

It is noted that some embodiments of the described method may not automatically schedule meetings, but seek to calculate a “meeting probability” threshold value that can be used to propose mutually available timeslots to participants. Scheduling tools, such as ‘Recommended Times,’ may use the method to provide recommendations that are helpful and not obstructive for meetings that have a high likelihood of being scheduled but have not yet been scheduled.

In some embodiments, the meeting probability may be calculated by tracking the relationship between high levels of digital communication (e.g., email, @username mentions, instant messaging, etc.) compared to historical cases of meetings being scheduled within a short time of similar volumes or spikes in communications.

In some embodiments, identifying a meeting probability means that a timeslot can be flagged and/or proposed without the need to actually schedule the meeting. Flagging the timeslot in this way may mean that other users of the scheduling system can still opt to book a meeting at the same time, but can be informed that choosing an alternative slot may save other users from initiating the rescheduling of meetings. Alternatively, the timeslot may be blocked, preventing another meeting from being scheduled that conflicts with the timeslot.

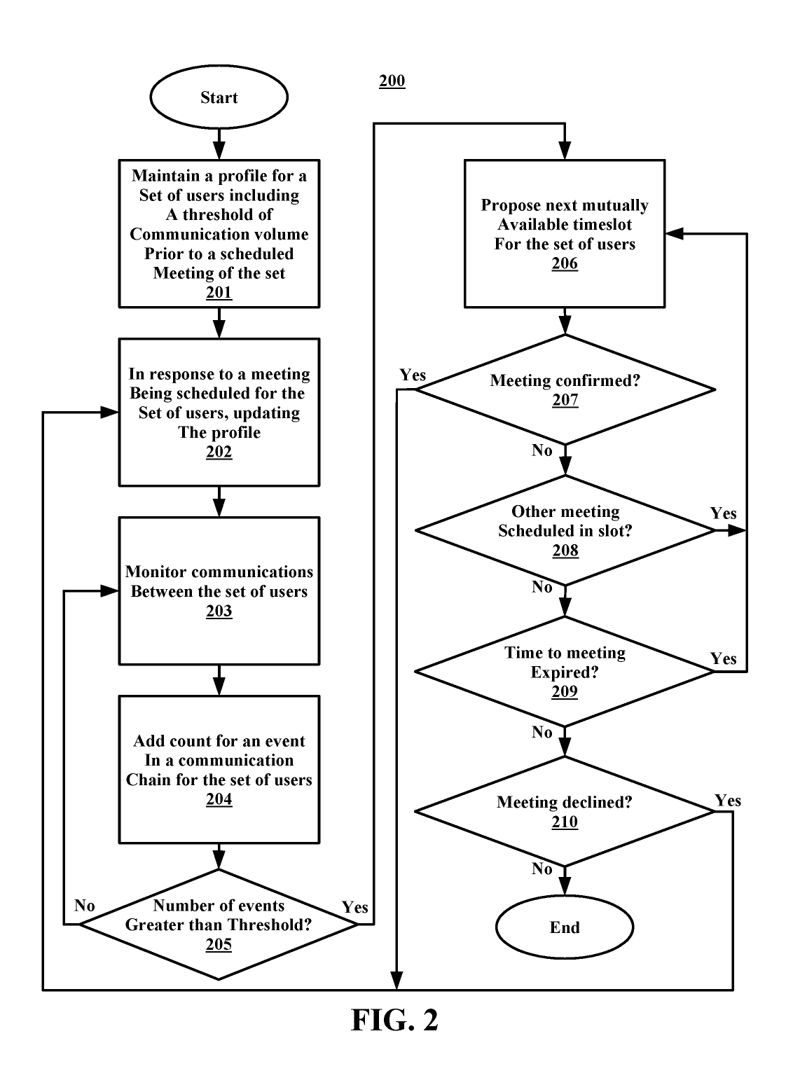

Referring to FIG. 2, illustrated is a flow diagram of an example method 200 of the described method of proposing timeslots in a shared calendar system in a collaborative communication environment, in accordance with embodiments of the present disclosure. In some embodiments, the method 200 may be performed by a processor.

The method 200 may begin at operation 201, where the processor maintains a profile for a set of users of the system. The profile may be used for identifying the relationship between the scheduling of a meeting for a set of users and the volume of digital communications within a time period preceding the act of scheduling the meeting.

The set of users may be any combination of users between whom there are electronic communications. Sets of users may be configured or may be learnt from monitoring communications between users in the collaborative communication environment. In one embodiment, a set of users may be participants in a communication chain or thread. Profiles may be maintained for any or multiple combination of users of a collaborative communication environment for which communication is not one-way. Exclusion of one-way communication ensures mass communications are excluded from the process. Sets of users may be configured together with configuration of settings for the set of users.

In some embodiments, the profile may include a threshold of a volume of communications between the users in the set prior to a meeting being scheduled for the set of users. This involves identifying when the volume of digital communications between the set of users within a rolling time interval exceeds the threshold at which the probability of those users needing to meet is high enough to warrant proposing a timeslot.

The threshold provides a measure of the level of communication between the set of users prior to the users historically having decided that they need to schedule a meeting. The volume of communications may be measured in a time period prior to the scheduling of the meeting. The duration of the time period may be configured for a set of users.

In response to a meeting being scheduled for the set of users, the method 200 may proceed to operation 202. In some embodiments, at operation 202 the processor may update the profile associated with the set of users based on examination of their communication within the time period prior to the scheduling of the meeting. The term meeting may include a conference call, a video conference, an in-person meeting, a conference interaction via messaging, or a combination of any of these. The term meeting is intended to include a real time interaction between all the participants.

After operation 202, the method 200 may proceed to operation 202. At operation 203, the processor may monitor communications between the set of users. The communications may be any form of electronic communication including, but not restricted to, email, @username mentions, instant messaging, and phone calls. The communication may be between any two or more of the set of users.

In some embodiments, after operation 203, the method 200 may proceed to operation 204. In operation 204, after an event in a communication flow or chain involving two or more of set of users, a count may be added, by the processor, to the communication volume for the set of users. A unit of communication may be defined (e.g., an email message sent or received) and a list of participants may be defined based on distinct user identifiers. In some embodiments, user identities may be resolved such that more than one form of communication by the user is linked, for example, a user's email address is treated as the same identity as a user name or handle. After each communication event, the count may be added for a set of users. That is, the count may be increased depending on the number of inactions within each communication event.

After operation 204, the method 200 may proceed to decision block 205, where the processor may determine if the number of communication events is above the threshold for the profile for the set of users in the time period. If the number of events has not reached the threshold, the processor may direct the method 200 to continue to monitor the communications between the set of users, as described in operation 203. This may be a rolling count in a rolling time period up to the current time.

In response to the time range exceeding the threshold score, the method 200 may proceed to operation 206. At operation 206, the processor may automatically propose the next mutually available timeslot for the set of users. The length of the proposed timeslot may automatically be configured for a set of users. This proposed timeslot may be presented to one or more of the users in the set of users. Proposed timeslots may be presented to all users, or used only to power recommendations for timeslots, depending on the implementation. In some embodiments, by automatically configuring a length of the proposed timeslot, the processor is able to more efficiently and quickly propose subsequent timeslots to the set of users. The processor may more quickly present subsequent proposed timeslots to the set of users by lessening the length (e.g., subtracting length, shifting the timeslot, etc.) of the proposed timeslot each time a meeting is presented and declined by a user, as discussed more fully in regard to decision block 210.

After operation 206, the method 200 may proceed to decision block 207, where it may be determined if the meeting is confirmed. If the meeting is confirmed, the processor may direct the method 200 to loop to update the profile, as described in operation 202. In some embodiments, it may be that additional communications occur after the threshold has been reached and the meeting proposed, but before the meeting is confirmed; these additional communications may be added to the count when updating the profile. In some embodiments, the processor may again monitor communication between the set of users after the meeting has taken place, as described in operation 203.

If no confirmation of the meeting is received, the method 200 may proceed to decision block 208, where the processor may determine, in the time prior to the start time of the proposed meeting, if another meeting is scheduled in the timeslot for one or more of the users rendering the timeslot unavailable. In an embodiment of the method 200, the proposed timeslot may be protected and therefore other meetings may be blocked from being scheduled. If another meeting is scheduled, the processor may direct the method 200 loop to operation 206, where the processor may propose a next available timeslot for the set of users.

In some embodiments, if it is determined no other meetings are scheduled at decision block 208, the method 200 may proceed to decision block 209. At decision block 209, it may be determined if the time to the meeting has expired. If it is determined at decision block 209, that the time to the meeting has expired and no meeting has been confirmed, the processor may direct the method 200 to loop to operation 206, where the processor may propose a next available timeslot for the set of users.

In some embodiments, the processor may keep a rolling check on the volume of communication in the period prior to the current time, and if this has dropped off below the threshold, a new timeslot for the meeting may not be proposed.

If, at decision block 209, it is determined that the time to the meeting has not expired, the method 200 may proceed to decision block 210. At decision block 210, the processor may determine if the meeting is declined. This may be an explicit declining by one of the set of users or may be due to a number of proposed meetings that have not been confirmed. For example, the proposed timeslot may roll until the opportunity to schedule the meeting has been implicitly declined x number of times, at which point it may expire.

In some embodiments, if it is determined at decision block 210 that the meeting has been declined the processor may direct the method 200 to operation 202. If it is determined at decision block 210 that the meeting has not been declined (e.g., accepted), the method 200 may end.

The implementation of the method 200 relies on a profile being maintained for pluralities of users within a collaborative environment. This allows a judgment to be made about the probability of the participants in a communication chain needing a timeslot proposed for the scheduling of a meeting.

A set of users may configure settings for the method 200 such as the period of time in which the volume of communications is monitored prior to scheduling a meeting, the length of the meeting, the user(s) who may confirm acceptance of a proposed timeslot, etc.

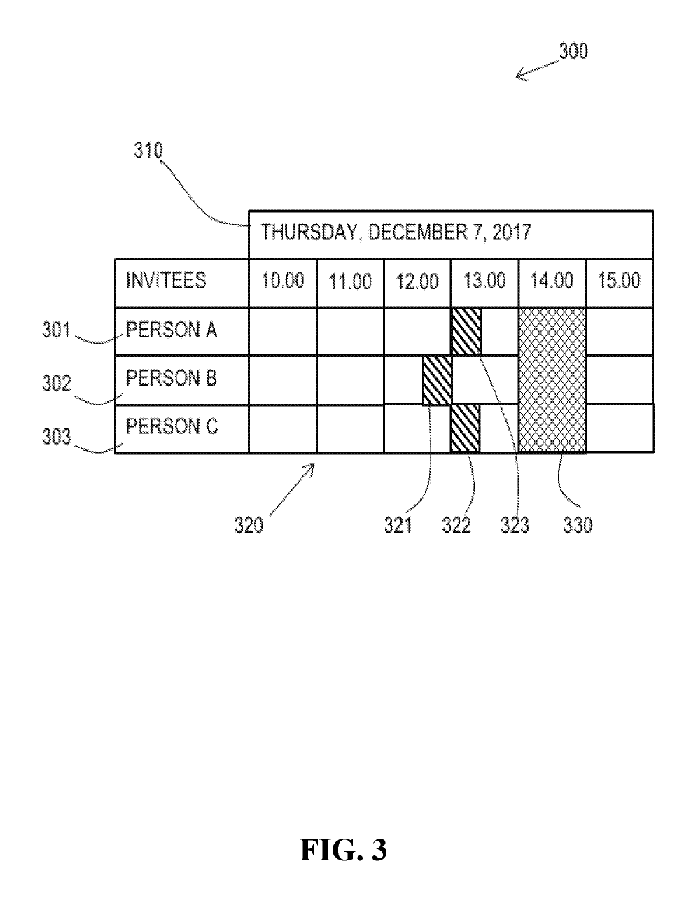

Referring to FIG. 3, illustrated is a schematic diagram of a shared calendar display 300. In some embodiments, the shared calendar display 300 may include a set of invitees (e.g., users), which are denoted as person A 301, person B 302, and person C 303. In some embodiments, the shared calendar display 300 may additionally include time periods 320 of a calendar day 310 for each person A-C 301, 302, and 303. For the purposes of this explanation, a case in which the set of invitees is three users Person A 301, Person B 302, Person C 303 is shown. This display may take many forms depending on the calendar software. Invitees may respectively have appointments 321, 322, and 323 already scheduled and showing in the time periods 320 of the shared calendar display 300.

At the time at which a meeting is scheduled, for example, when Person A 301 invites Person B 302 and Person C 303 to meet, each respective persons' A-C 301, 302, and 303 profiles are updated based on examination of each person's A-C 301, 302, and 303 communications within the last configurable range of time, such as 4 hours.

Profiles may be for a set of multiple invitees (e.g., users). In this case the following profiles may be updated. A communication between two invitees (1, 2, 3) may count in the set of three invitees (4).

1. Person A 301-Person B 302

2. Person A 301-Person C 303

3. Person B 302-Person C 303

4. Person A 301-Person B 302-Person C 303

Each profile of the persons A-C 301, 302, and 303 may be updated with the volume of communications executed within the range. A profile for the set of three users, Person A 301, Person B 302, Person C and 303 may be as shown in Table 1:

TABLE 1

| | Number of communications |
|---|---|
| Meeting booking | within the preceding 4 hours |
| 001 | 23 |
| 002 | 10 |
| 003 | 5 |
| 004 | 22 |
| 005 | 14 |

Based on profile data, a threshold may be calculated based on, for example, the average number of communications that precedes a booking. In the case illustrated in Table 1, the threshold value is 15 communications (i.e., the mean of the number of communications rounded up).

The following process may be performed after each event within a communication chain (i.e., an email being sent/replied to):

1) Does the number of communications within the configured time range of 4 hours exceed the threshold score of 15 for the profile of this set of invitees? If yes, go to step 2). If no, take no additional action.

2) Protect the next mutually available 1-hour timeslot for the set of invitees who satisfied the threshold conditions. This is illustrated as timeslot 330 in FIG. 3.

If the timeslot duration is 1 hour, then it may roll to the next mutually available window and roll again once the start time is missed without the meeting being scheduled.

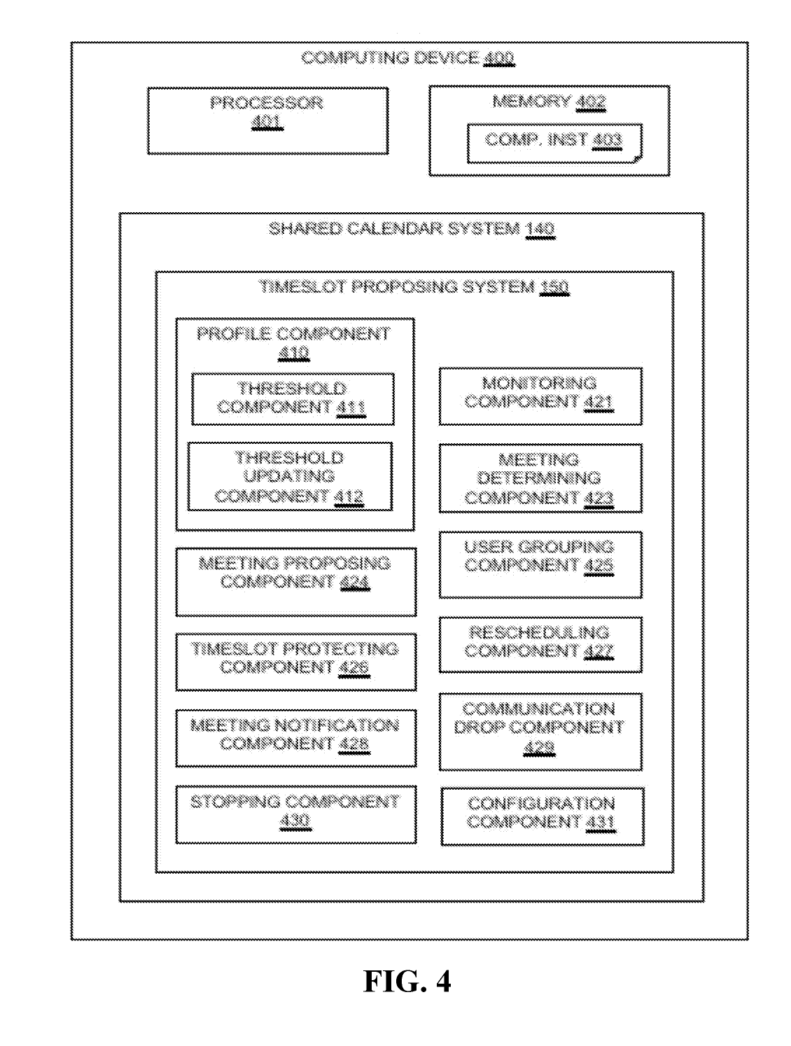

Referring to FIG. 4, illustrated is a block diagram of a computing device 400 that may host a shared calendar system 140 including or associated with a timeslot proposing system 150. In some embodiments, the shared calendar system 140 and the timeslot proposing system 150 may be the same or substantially similar shared calendar system 140 and timeslot proposing system 150 of FIG. 1.

The computing device 400 may include at least one processor 401, a hardware module, or a circuit for executing the functions of the described components which may be software units executing on the at least one processor 401. Multiple processors running parallel processing threads may be provided enabling parallel processing of some or all of the functions of the components. The computing device 400 may additionally include a memory 402, which may be configured to provide computer instructions 403 to the at least one processor 401 to carry out the functionality of the components.

The timeslot proposing system 150 may include a profile component 410 for maintaining a profile for a set of users of the shared calendar system 140 including a threshold component 411 for maintaining a threshold of communication volume prior to scheduling a meeting. The profile component 410 may also include a threshold updating component 412 for updating the threshold in the profile when meetings are scheduled for the set of users.

The timeslot proposing system 150 may include a monitoring component 421 for examining communications between the set of users within a configurable time period prior to the time of scheduling the meeting and in response to a meeting being scheduled, the threshold updating component 412 may update the threshold based on the monitored communications.

The timeslot proposing system 150 may include a meeting determining component 423 for, after each event in a communication chain involving the set of users, determining whether the volume of communications within a prior time period of the duration of the configurable time period exceeds the threshold for the profile for the set of users and a meeting proposing component 424 for, in response to the volume of communications exceeding the threshold, proposing the next mutually available timeslot for the set of users. The meeting proposing component 424 may communicate the proposed meeting to one or more users in the set of users by indicating the proposed timeslot in each respective users' calendar instances 111, 121, and 131, as described in FIG. 1, enabling the users to confirm the meeting or decline it.

The timeslot proposing system 150 may include a user grouping component 425 for determining a set of users by monitoring communications and grouping sets of users by participants in a communication chain.

The timeslot proposing system 150 may include a timeslot protecting component 426 for preventing other appointments being arranged for any one of the participants of a set of users overlapping a proposed timeslot.

The timeslot proposing system 150 may include a rescheduling component 427 for determining that a proposed timeslot is not available and proposing a next mutually available timeslot for the set of users thereby rolling the scheduling forward. The rescheduling component 427 may be activated in response to a proposed timeslot start time being reached without the meeting being confirmed.

The timeslot proposing system 150 may include a meeting notification component 428 for determining that another meeting is scheduled in the timeslot including one or more of the set of users and activating the rescheduling component 427.

The timeslot proposing system 150 may include a communication drop component 429 for stopping the rolling schedule if the volume of communications falls by a configurable amount.

The timeslot proposing system 150 may include a stopping component 430 for stopping the rolling schedule if a predefined number of proposed meetings are not confirmed or the proposed meeting is explicitly declined.

The timeslot proposing system 150 may include a configuration component 431 for configuring settings for a set of users including one or more of the group of: a duration of the configurable time period; a duration of the timeslot; a number of unconfirmed proposed meetings before stopping rescheduling a meeting.

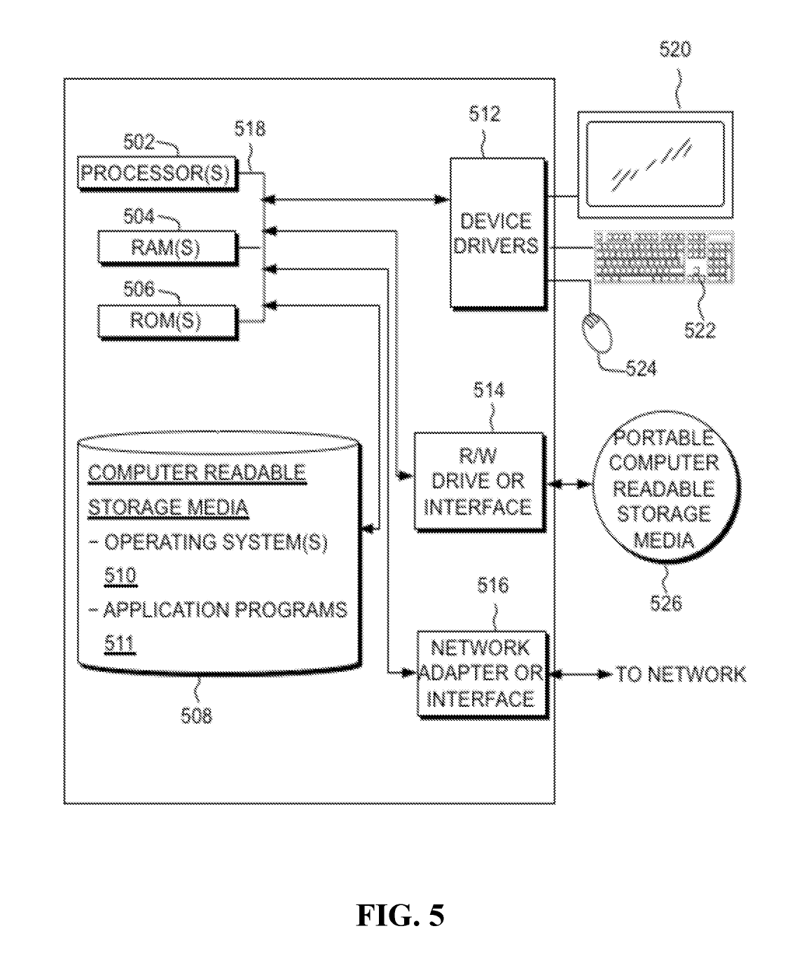

FIG. 5 depicts a block diagram of components of a computing device 400 in accordance with an embodiment of the present disclosure. It should be appreciated that FIG. 5 provides only an illustration of one implementation and does not imply any limitations with regard to the environments in which different embodiments may be implemented. Many modifications to the depicted environment may be made.

Computing device 400 can include one or more processors 502, one or more computer-readable RAMs 504, one or more computer-readable ROMs 506, one or more computer readable storage media 508, device drivers 512, read/write drive or interface 514, and network adapter or interface 516, all interconnected over a communications fabric 518. Communications fabric 518 can be implemented with any architecture designed for passing data and/or control information between processors (such as microprocessors, communications and network processors, etc.), system memory, peripheral devices, and any other hardware components within the system.

One or more operating systems 510, and application programs 511, such as calendar systems 140 are stored on one or more of the computer readable storage media 508 for execution by one or more of the processors 502 via one or more of the respective RAMs 506 (which typically include cache memory). In the illustrated embodiment, each of the computer readable storage media 508 can be a magnetic disk storage device of an internal hard drive, CD-ROM, DVD, memory stick, magnetic tape, magnetic disk, optical disk, a semiconductor storage device such as RAM, ROM, EPROM, flash memory, or any other computer readable storage media that can store a computer program and digital information, in accordance with embodiments of the disclosure.

Computing device 400 can also include a R/W drive or interface 514 to read from and write to one or more portable computer readable storage media 526. Application programs 511 on computing device 400 can be stored on one or more of the portable computer readable storage media 526, read via the respective R/W drive or interface 514 and loaded into the respective computer readable storage media 508.

Computing device 400 can also include a network adapter or interface 516, such as a TCP/IP adapter card or wireless communication adapter. Application programs 511 on computing device 400 can be downloaded to the computing device from an external computer or external storage device via a network (for example, the Internet, a local area network or other wide area networks or wireless networks) and network adapter or interface 516. From the network adapter or interface 516, the programs may be loaded into the computer readable storage media 508. The network may comprise copper wires, optical fibers, wireless transmission, routers, firewalls, switches, gateway computers and edge servers.

Computing device 400 can also include a display screen 520, a keyboard or keypad 522, and a computer mouse or touchpad 524. Device drivers 512 interface to display screen 520 for imaging, to keyboard or keypad 522, to computer mouse or touchpad 524, and/or to display screen 520 for pressure sensing of alphanumeric character entry and user selections. The device drivers 512, R/W drive or interface 514, and network adapter or interface 516 can comprise hardware and software stored in computer readable storage media 508 and/or ROM 506.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Cloud Computing

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

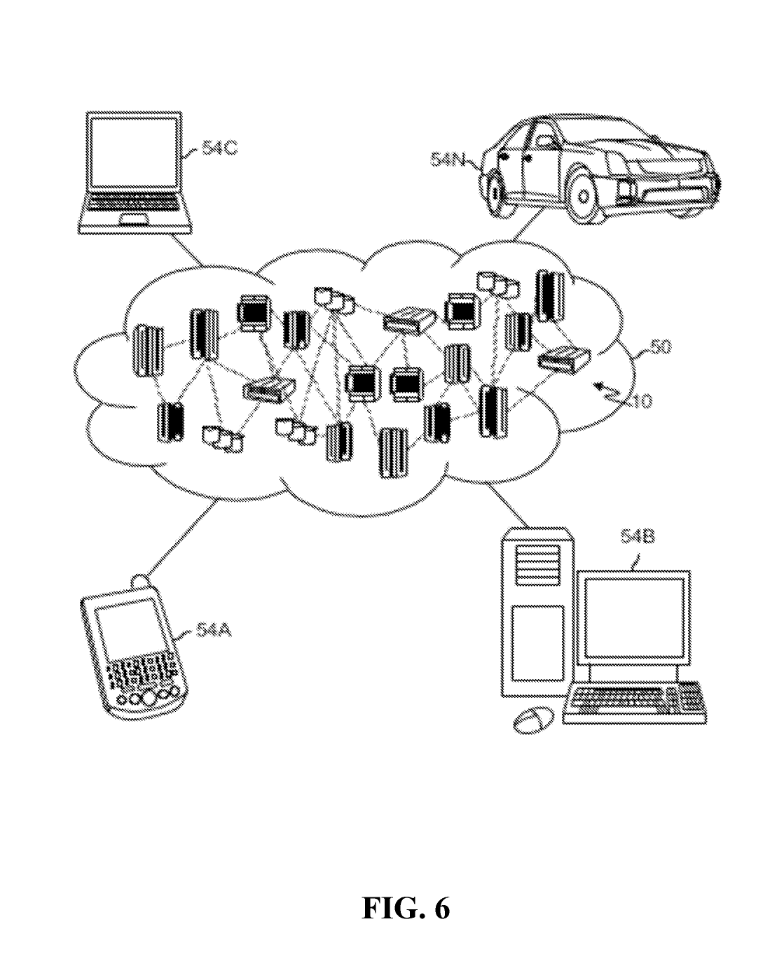

Referring now to FIG. 6, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 6 are intended to be illustrative only and that computing nodes 10 and cloud computing environment 50 can communicate with any type of computerized device over any type of network and/or network addressable connection (e.g., using a web browser).

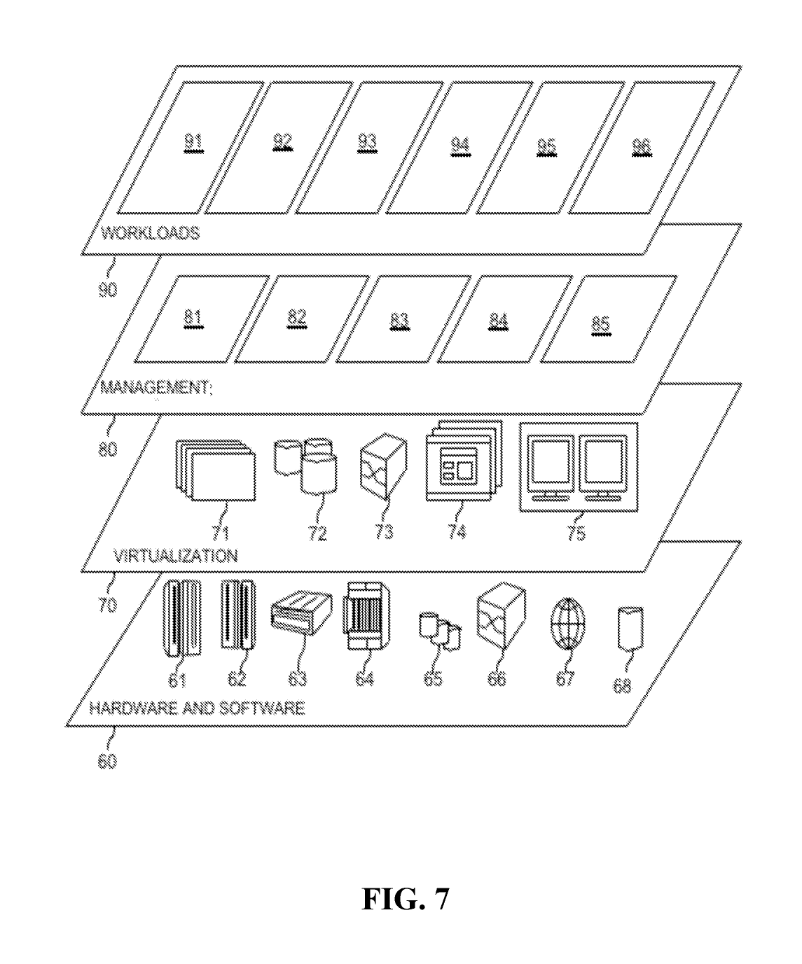

Referring now to FIG. 7, a set of functional abstraction layers provided by cloud computing environment 50 (FIG. 6) is shown. It should be understood in advance that the components, layers, and functions shown in FIG. 7 are intended to be illustrative only and embodiments of the disclosure are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and meeting scheduling processing 96.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

What is claimed is:

1. A computer-implemented method for automatic scheduling in a shared calendar system, comprising:
maintaining a profile for a set of users of the shared calendar system including a threshold of communication volume prior to scheduling a meeting;
updating the threshold in the profile in response to a meeting being scheduled for the set of users based on examination of communications between the set of users within a configurable time period prior to the time of scheduling the meeting;
determining, after each event in a communication chain involving the set of users, whether the volume of communications within a prior time period of the duration of the configurable time period exceeds the threshold for the profile for the set of users; and
proposing, in response to the volume of communications exceeding the threshold, the next mutually available timeslot for the set of users.

2. The method of claim 1, wherein the set of users is determined by monitoring communications and grouping sets of users by participants in a communication chain.

3. The method of claim 1, wherein the threshold of communication volume is determined by an average number of communication events prior to previously scheduled meetings for the set of users.

4. The method of claim 1, wherein proposing the next mutually available timeslot prevents other appointments being arranged for any one of the set of users overlapping the timeslot.

5. The method of claim 1, further comprising:
determining that a proposed timeslot is not available; and
proposing a next mutually available timeslot for the set of users by rolling the scheduling forward.

6. The method of claim 5, wherein determining that a proposed timeslot is not available includes determining that another meeting is scheduled in the timeslot including one or more of the set of users.

7. The method of claim 5, wherein determining that a proposed timeslot is not available includes reaching the start time of the proposed timeslot without the meeting being confirmed.

8. The method of claim 5, further comprising:
stopping the rolling schedule if the volume of communications falls by a configurable amount.

9. The method of claim 5, further comprising:
stopping the rolling schedule if a predefined number of proposed meetings are not confirmed.

10. The method of claim 1, further comprising:
configuring settings for a set of users, wherein the configured settings include a duration of the configurable time period, a duration of the timeslot, and a number of unconfirmed proposed meetings before stopping and rescheduling a meeting.

11. A system for automatic scheduling in a shared calendar system, comprising:
a processor; and
a memory configured to provide computer program instructions to the processor to execute the function of the components:
a profile component for maintaining a profile for a set of users of the shared calendar system including a threshold component for maintaining a threshold of communication volume prior to scheduling a meeting;
a threshold updating component for updating the threshold in the profile in response to a meeting being scheduled for the set of users based on a monitoring component examining communications between the set of users within a configurable time period prior to the time of scheduling the meeting;
a meeting determining component for, determining, after each event in a communication chain involving the set of users, whether the volume of communications within a prior time period of the duration of the configurable time period exceeds the threshold for the profile for the set of users; and
a meeting proposing component for, proposing, in response to the volume of communications exceeding the threshold, the next mutually available timeslot for the set of users.

12. The system of claim 11, further comprising:
a user grouping component for determining a set of users by monitoring communications and grouping sets of users by participants in a communication chain.

13. The system of claim 11, further comprising:
a timeslot protecting component for preventing other appointments being arranged for any one of the set of users overlapping the proposed timeslot.

14. The system of claim 11, further comprising:
a rescheduling component for determining that a proposed timeslot is not available and proposing a next mutually available timeslot for the set of users thereby rolling the scheduling forward.

15. The system of claim 14, further comprising:
a meeting notification component for determining that another meeting is scheduled in the timeslot including one or more of the set of users and activating the rescheduling component.

16. The system of claim 14, wherein the rescheduling component is activated in response to a proposed timeslot start time being reached without the meeting being confirmed.

17. The system of claim 14, further comprising:
a communication drop component for stopping the rolling schedule if the volume of communications falls by a configurable amount.

18. The system of claim 14, further comprising:
a stopping component for stopping the rolling schedule if a predefined number of proposed meetings are not confirmed.

19. The system of claim 11, further comprising:
a configuration component for configuring settings for a set of users, wherein the configured settings include a duration of the configurable time period, a duration of the timeslot, and a number of unconfirmed proposed meetings before stopping and rescheduling a meeting.

20. A computer program product for automatic scheduling in a shared calendar system, the computer program product comprising a non-transitory computer readable storage medium having program instructions embodied therewith, the program instructions executable by a processor to cause the processor to:
maintain a profile for a set of users of the shared calendar system including a threshold of communication volume prior to scheduling a meeting;
update the threshold in the profile in response to a meeting being scheduled for the set of users based on examination of communications between the set of users within a configurable time period prior to the time of scheduling the meeting;
determine, after each event in a communication chain involving the set of users, whether the volume of communications within a prior time period of the duration of the configurable time period exceeds the threshold for the profile for the set of users; and
propose, in response to the volume of communications exceeding the threshold, the next mutually available timeslot for the set of users.
